(19) United States
(12) Patent Application Publication
(10) Pub. No.: US 2013/0115892 A1
(43) Pub. Date: May 9, 2013

(54) METHOD FOR MOBILE COMMUNICATION

(71) Applicant: Michael Kurz, Wien (AT)

(72) Inventor: Michael Kurz, Wien (AT)

(73) Assignee: T-MOBILE INTERNATIONAL AUSTRIA GMBH, Wien (AT)

(21) Appl. No.: 13/810,228

(22) PCT Filed: Jul. 12, 2011
(86) PCT No.: PCT/EP2011/003477

§ 371 Date: Jan. 15, 2013

(30) Foreign Application Priority Data
Jul. 16, 2010 (EP) 10007387.3

(51) Int. Cl. H04W 24/02

(52) U.S. Cl. CPC H04W 24/02
USPC 455/67.14

(57) ABSTRACT

A method for transferring audio data in a mobile radio network, the mobile radio network having a first mobile device in a first location and a second mobile device in a second location, includes: transmitting, by the first mobile device, a pilot signal to the second mobile device; measuring, by the second mobile device, a signal strength of the pilot signal; transmitting, by the second mobile device, information related to the signal strength of the pilot signal to the first mobile device; determining, by the first mobile device, the second location relative to the first location based on the information related to the signal strength; and transmitting, by the first mobile device, an audio signal based on the second location to the second mobile device.

### CROSS-REFERENCE TO RELATED APPLICATIONS

This application is a U.S. National Phase application under 35 U.S.C. §371 of International Application No. PCT/EP2011/003477, filed on Jul. 12, 2011, and claims benefit to European Patent Application No. EP 10007387.3, filed on Jul. 16, 2010. The International Application was published in English on Jan. 19, 2012 as WO 2012/007152 A1 under PCT Article 21(2).

### FIELD

The present invention relates to a method, a client, a system, a program and a computer program product for mobile communication.

Particularly, the present invention relates to transferring audio information.

### BACKGROUND

The mobile device industry is constantly challenged in the market place for high tier products having unique features. For example, demand for mobile devices which play music has dramatically risen. Today music portable devices are very popular, and there are multiple types of devices supporting music playback such as MP3 Players, cell phones, and satellite radio systems. These devices are capable of reproducing music stored or downloaded to the device. Users can download different songs or music clips and listen to the music played by the device. For example, the device may individually support stereo rendering of sound. Consequently, when using headsets or earphones, the user can be immersed in the music experience. However, in non-headset or non-earphone mode, such devices are generally incapable of generating a true stereo experience. Due to the small size of the device and the small number of available speakers, the device is generally limited to mono sound. Also, in some cases, more than one user may want to listen to music together. Accordingly, sharing the music experience with more than one user, without a headset or earphones, does not provide a stereo rendering of the music. A need therefore exists for providing stereo sound for sharing a music experience with multiple users.

Such methods are described e.g. in document US2007/0087686 A1. This document discloses a method for playing back audio data on an audio playback device such as an audio playback enabled mobile phone. The method comprises receiving multi-channel audio data, in an audio playback device, obtaining first channel audio data from said multi-channel audio data for playback, and playing back said first channel audio data via at least one loudspeaker of said audio playback device.

The drawback of methods according to the prior art is that the devices must not move during sound playback because otherwise the sound playback is significantly disturbed. Therefore there is an urgent need for a method that provides the playback of audio data even during movement of the mobile devices.

This is only one drawback that is solved by the present invention explained in the following.

### SUMMARY

In an embodiment, the present invention provides a method for transferring audio data in a mobile radio network. The mobile radio network includes a first mobile device in a first location and a second mobile device in a second location. The method includes: transmitting, by the first mobile device, a pilot signal to the second mobile device; measuring, by the second mobile device, a signal strength of the pilot signal; transmitting, by the second mobile device, information related to the signal strength of the pilot signal to the first mobile device; determining, by the first mobile device, the second location relative to the first location based on the information related to the signal strength; and transmitting, by the first mobile device, an audio signal based on the second location to the second mobile device.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIGS. 1 to 4 show schematically exemplary embodiments of the present invention.

### DETAILED DESCRIPTION

In an embodiment, the present invention provides a method for transferring audio data in a mobile radio network, wherein the mobile radio network comprises a first mobile device in a first location and a second mobile device in a second location, wherein the first mobile device transmits a pilot signal to the second mobile device, wherein the second mobile device measures a signal strength of the pilot signal, wherein the second mobile device transmits an information related to the signal strength of the pilot signal to the first mobile device, wherein the first mobile device determines the second location relative to the first location depending on the information related to the signal strength, wherein the first mobile device transmits an audio signal depending on the second location to the second mobile device.

According to the present invention it is advantageously possible to playback audio data even during movement of the mobile devices without any negative impact on the played back audio data caused by the movement of the mobile devices. Even during movement of the mobile devices, the first mobile device can determine the second location of the second mobile device comparatively exactly and adapt optimally the audio signal that is transmitted to the second mobile device in dependence of the second location. Furthermore, there is no need for a stationary server and/or for an infrastructural network.

In the following further exemplary embodiments of the present invention are described.

But it will be understood by any person skilled in the art that these exemplary embodiments are merely used for illustrative purposes and do not limit the scope of protection defined by the claims.

According to the present invention it is preferred that the pilot signal, the information related to the signal strength and/or the audio signal are transmitted using Bluetooth, NFC (Near Field Communication), RFID (Radio Frequency Identification), WIMAX (Worldwide Interoperability for Microwave Access), or WLAN (Wireless Local Area Network) connection. In the context of the present invention, a Bluetooth connection is a wireless connection making use of the 2.4 GHz ISM band.

According to the present invention it is thereby advantageously possible to use existing connection means for realization of the present invention.

According to the present invention it is preferred that the first mobile device receives sound data from a local memory device, preferably a memory stick, and/or a network entity, preferably using Bluetooth, NFC, RFID, WIMAX or WLAN connection, wherein the audio signal is generated depending on the sound data.

According to the present invention it is thereby advantageously possible to easily provide sound data to the first mobile device.

According to the present invention it is preferred that the sound data comprises mono sound, stereo sound and/or surround sound information.

According to the present invention it is thereby advantageously possible to provide different kind of sound data to the first mobile device.

According to the present invention it is preferred that the first mobile device determines sound capabilities of the second mobile device, wherein preferably the sound capabilities comprise data processing capacity, battery capacity, and/or speaker volume level, wherein the first mobile device provides the audio signal depending on the sound capabilities to the second mobile device.

According to the present invention it is thereby advantageously possible to optimize the audio signal even if there are different capabilities of the second mobile devices.

According to the present invention it is preferred that the first mobile device determines locations and sound capabilities of a plurality of second mobile devices, wherein the first mobile device generates a surround sound depending on the locations and the sound capabilities of the plurality of second mobile devices, wherein each of the plurality of second mobile devices contributes a portion of the surround sound.

According to the present invention it is thereby advantageously possible to provide surround sound even if the second mobile devices and/or the first mobile device are moving.

According to the present invention it is preferred that mobile devices entering or leaving the proximity of the first mobile device are added to or removed from the plurality of second mobile devices.

According to the present invention it is thereby advantageously possible to provide e.g. surround sound even if devices are exchanging in the proximity of the first mobile device.

According to the present invention it is preferred that an internal compass or a gyro sensor or an acceleration sensor is used for determination of the direction of the second mobile device relating to the first mobile device.

The invention further relates to a system for transferring audio data in a mobile radio network, wherein the mobile radio network comprises a first mobile device in a first location and a second mobile device in a second location, characterized in that the first mobile device transmits a pilot signal to the second mobile device, wherein the second mobile device measures a signal strength of the pilot signal, wherein the second mobile device transmits an information related to the signal strength of the pilot signal to the first mobile device, wherein the first mobile device determines the second location relative to the first location depending on the information related to the signal strength, wherein the first mobile device transmits an audio signal depending on the second location to the second mobile device.

The invention further relates to a first mobile device for transferring audio data in a mobile radio network, wherein the mobile radio network comprises the first mobile device in a first location and a second mobile device in a second location, wherein the first mobile device transmits a pilot signal to the second mobile device, wherein the first mobile device receives an information related to the signal strength of the pilot signal from the second mobile device, wherein the first mobile device determines the second location relative to the first location depending on the information related to the signal strength, wherein the first mobile device transmits an audio signal depending on the second location to the second mobile device.

The invention further relates to a program comprising a computer readable program code which, when executed on a computer, causes the computer to perform a method according to the present invention. The invention further relates to a computer program product comprising a computer program stored on a storage medium, wherein the computer program comprises a computer readable program code which, when executed on a computer, causes the computer to perform a method for transferring audio data in a mobile radio network according to the present invention.

According to the present invention it is thereby advantageously possible to playback audio data even during movement of the mobile devices because the sound playback is not significantly disturbed.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

According to the present invention several mobile devices (UE's) can be used to enable surround sound even if they are moving. Also one or more devices can receive surround sound depending on their position, even if they move between rooms. For a good impression of surround sound a precise (or preferably exact) position of each loudspeaker should be known by the audio source device for calculating spatial diversity. Otherwise spatial distortion could occur, which would badly affect the user's sound impression.

With the support of GPS (global positioning system) the position can be determined with accuracy of several meters or even with help of DGPS (digital global positioning system) of several centimeters. Relying on satellite signals is limited to outdoor applications because of the weak received signals from the satellites indoors. A precise (or preferably exact) location determination of such devices needs to be done indoors in other ways.

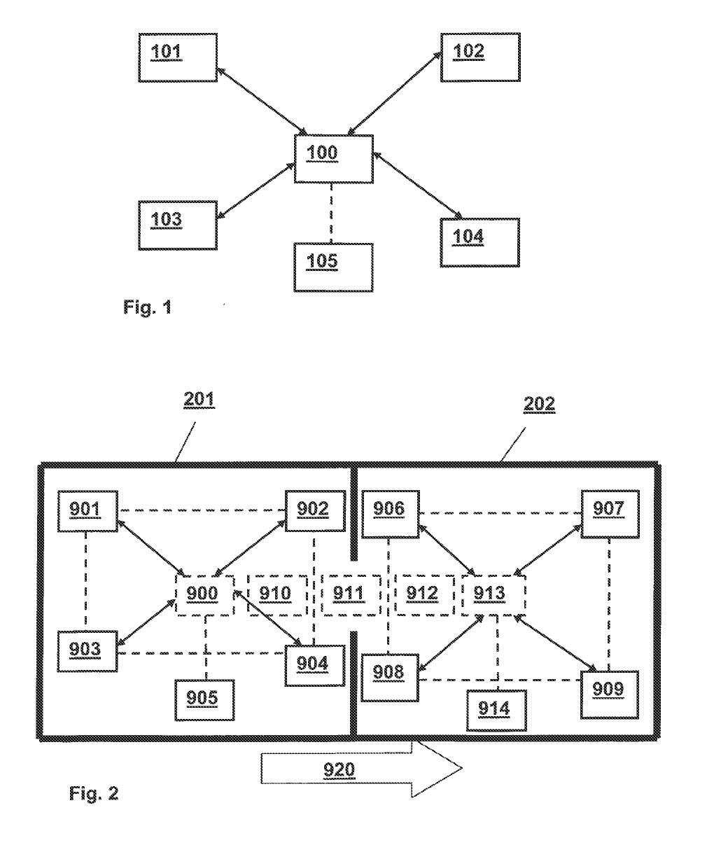

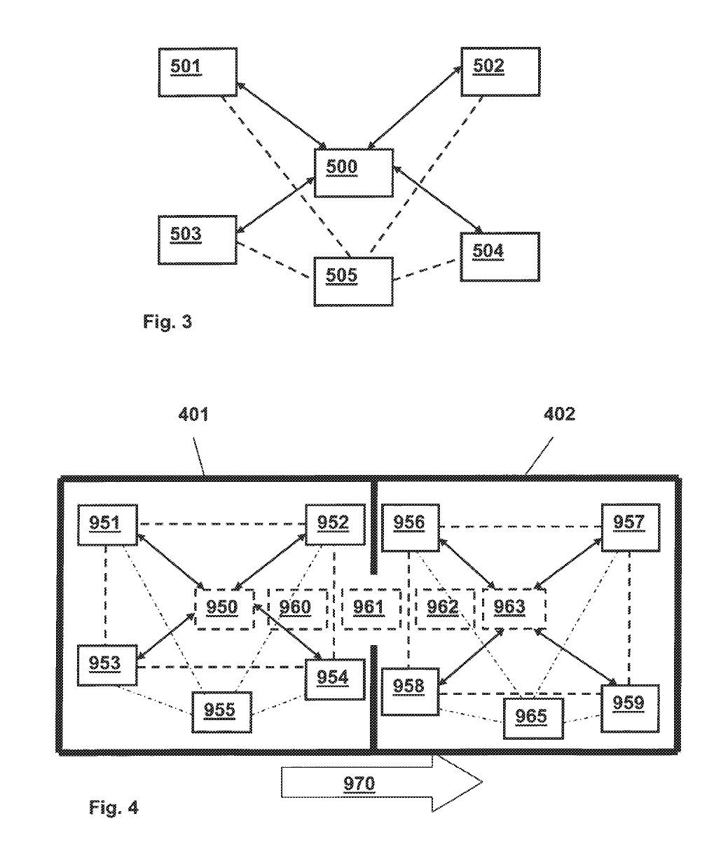

Nowadays loudspeakers built in mobile devices (e.g. mobile phones) are able to play music/voice data loud enough for bigger auditorium. People around a centered device (Server) could experience surround sound delivered from the client devices around. While moving also the spatial diversion and signal level in the clients will be adopted according to the position of the Server device (initially to be considered to be centered). Special reverb profiles could be enabled and adopted by the user. FIG. 1 shows schematically an embodiment of the present invention. A centered device (Server) 100 receives prepared surround data (e.g. 4 channels) via source 105. The source 105 is e.g. a local memory (e.g. memory stick, etc.) or a network (e.g. mobile network, Bluetooth, WLAN, USB, etc.). Centered device (Server) 100 distributes sound data to stationary clients 101, 102, 103, 104. Prepared surround data will be played accordingly by the clients on demand by the server. According to a further embodiment the devices are not stationary but mobile. In this case the centered device 100 calculates spatial diversity and signal level for each client 101, 102, 103, 104. Prepared surround data will be distributed from server 100 to the clients. Prepared surround data will be played accordingly by the clients on demand by the server. According to this embodiment it as advantageously possibly that the clients are moving while providing surround sound.

According to a further embodiment the centered device (Server) 100 receives sound data (Mono or Stereo) via source 105. The source 105 is e.g. a local memory (e.g. memory stick, etc.) or a network (e.g. mobile network, Bluetooth, WLAN, USB, etc.). Centered device (Server) 100 calculates spatial diversity and signal level for each client 101, 102, 103, 104. Prepared surround data will be distributed from server 100 to the clients. Prepared surround data will be played accordingly by the clients on demand by the server. According to this embodiment it as advantageously possibly that the clients are moving while providing surround sound.

According to a further embodiment the centered device (Server) 100 receives sound data (Mono or Stereo) via source 105. The source 105 is e.g. a local memory (e.g. memory stick, etc.) or a network (e.g. mobile network, Bluetooth, WLAN, USB, etc.). The centered device (Server) 100 distributes sound data to the clients. The clients calculate spatial diversity and signal level for each client. Calculated surround data will be played accordingly by the clients on demand by the server. According to this embodiment it as advantageously possibly that the clients are moving while providing surround sound.

According to a further embodiment a handover is provided e.g. when the server moves from one room into the other room. FIG. 2 shows schematically a further embodiment of the present invention. In a first room 201 a centered device (Server) 900 receives prepared surround data or sound data (Mono or Stereo) via source 905. The source 905 is e.g. a local memory (e.g. memory stick, etc.) or a network (e.g. mobile network, Bluetooth, WLAN, USB, etc.). Centered device (Server) 900 calculates spatial diversity and signal level for each client 901, 902, 903, 904. Prepared surround data will be distributed from server 900 to the clients. Prepared surround data will be played accordingly by the clients on demand by the server. In this embodiment the server 900 moves in direction 920 from the first room 201 into a second room 202. During this movement the server 900 starts from position 900 and reaches the positions 910, 911, 912, 913. Position 913 is the end position if the movement. In the second room 202 the centered device (Server) receives prepared surround data or sound data (Mono or Stereo) via source 914. The source 914 is e.g. a local memory (e.g. memory stick, etc.) or according to a further embodiment even the same source like 905 or a network (e.g. mobile network, Bluetooth, WLAN, USB, etc.). The centered device (Server) calculates spatial diversity and signal level for each client 906, 907, 908, 909. Prepared surround data will be distributed from the server to the clients. Prepared surround data will be played accordingly by the clients on demand by the server. According to the present invention it is advantageously possible to provide a non noticeable interruption during moving from one to the other room, which means that e.g. client 906 takes more and more sound data over from client 902 (e.g. 0% at position 900, 25% at position 910, 50% at position 911, 75% at position 912, 100% at position 913). The positions between the starting position 900 and the end position 913 are not limited and would result in any value of related signal level from 0% to 100%.

The following table 1 shows reached signal levels for each channel of the client. For better handover procedure the direction of the client may be useful to know, which could be preferably determined by an internal compass or by a gyro sensor or an acceleration sensor in the client.

TABLE 1
Allocation of signal levels

| | | | Signal | Signal | Signal | Signal |
|---|---|---|---|---|---|---|
| | | | level | level | level | level |
| | Position | Direction | Channel | Channel | Channel | Channel |
| Location | of | of | Left | Left | Right | Right |
| of Server | Server | Server | Rear | Front | Front | Rear |
| Room 201 | 900 | 920 | 901 | 902 | 904 | 903 |
| | | | (100%) | (100%) | (100%) | (100%) |
| Room 201 | 910 | 920 | 901 | 902 | 904 | 903 |
| | | | (75%) | (75%) | (75%) | (75%) |
| | | | 902 | 906 | 908 | 904 |
| | | | (25%) | (25%) | (25%) | (25%) |
| Room 201- | 911 | 920 | 901 | 902 | 904 | 904 |
| 202 | | | (50%) | (50%) | (50%) | (50%) |
| | | | 902 | 906 | 908 | 903 |
| | | | (50%) | (50%) | (50%) | (50%) |
| Room 202 | 912 | 920 | 902 | 906 | 908 | 904 |
| | | | (25%) | (25%) | (25%) | (25%) |
| | | | 906 | 907 | 909 | 908 |
| | | | (75%) | (75%) | (75%) | (75%) |
| Room 202 | 913 | 920 | 906 | 907 | 909 | 908 |
| | | | (100%) | (100%) | (100%) | (100%) |

The transmission of sound data from the clients to loudspeakers could be wired or wireless. In a preferred embodiment the loudspeakers are built in the clients. The signals between the devices (Server and Clients) are preferably encrypted with a defined length of an encryption key. Each device (Server and Clients) preferably has a special identity (ID) for exact identification. Preferably for better performance, e.g. handover procedure, the direction from the client to the server could be determined by an internal compass or by a gyro sensor or an acceleration sensor in the server.

According to a further embodiment the position of four cornered devices (Servers) 501, 502, 503, 504 are known or determined and one or more centered devices (clients) 500 are moving in between. While moving also the spatial diversion and signal level in the client(s) 500 will be adapted according to the position of the client device(s) 500 (initially to be considered to be centered). In this embodiment the client devices 500 comprises preferably a special surround headphone, so that the user can experience the surround sound with the client device 500. Special reverb profiles could preferably be enabled and adopted by the user.

According to a further embodiment the corner devices (Servers) 501, 502, 503, 504 receive prepared surround data (e.g. 4 channels) via source 505. The source 505 is e.g. a local memory (e.g. memory stick, etc.) or a network (e.g. mobile network, Bluetooth, WLAN, USB, etc.). The cornered devices (Server) 501, 502, 503, 504 distribute sound data to Client 500.

According to a further embodiment the corner devices (Servers) 501, 502, 503, 504 receive sound data (Mono or Stereo) via source 505. The source 505 is e.g. a local memory (e.g. memory stick, etc.) or a network (e.g. mobile network, Bluetooth, WLAN, USB, etc.). The corner devices (Servers) calculate spatial diversity and signal level for the client 500. Prepared surround data will be distributed from the servers to the client. Calculated surround data will be played accordingly by the client 500 on demand from the servers. According to this embodiment it as advantageously possibly that the client 500 is moving while providing surround sound.

According to a further embodiment the corner devices (Servers) 501, 502, 503, 504 receive sound data (Mono or Stereo) via source 505. The source 505 is e.g. a local memory (e.g. memory stick, etc.) or a network (e.g. mobile network, Bluetooth, WLAN, USB, etc.). The corner devices (Servers) 501, 502, 503, 504 distribute sound data to client 500. The client 500 calculates spatial diversity and signal level for the client itself Calculated surround data will be played accordingly by the client 500 on demand from the client itself. According to this embodiment it as advantageously possibly that the client 500 is moving while providing surround sound.

According to a further embodiment a handover is provided e.g. when the client moves from one room into the other room. FIG. 4 shows schematically a further embodiment of the present invention. In a first room 401 the corner devices (Servers) 951, 952, 953, 954 receive prepared surround data (e.g. 4 channels) or sound data (Mono or Stereo) via source 955. The source 955 is e.g. a local memory (e.g. memory stick, etc.) or a network (e.g. mobile network, Bluetooth, WLAN, USB, etc.). The cornered devices (Server) 951, 952, 953, 954 distribute sound data to Client 950. In a second room 402 the corner devices (Servers) 956, 957, 958, 959 receive prepared surround data (e.g. 4 channels) or sound data (Mono or Stereo) via source 965. The source 965 is e.g. a local memory (e.g. memory stick, etc.) or according to a further embodiment even the same source like 955 or a network (e.g. mobile network, Bluetooth, WLAN, USB, etc.). The cornered devices (Server) 956, 957, 958, 959 distribute sound data to clients located in the second room 402. The corner devices (Servers) calculate spatial diversity and signal level for the client. Prepared surround data will be distributed from the servers to the client. Calculated surround data will be played accordingly by the client on demand from the servers. In this embodiment the client 950 moves in direction 970 from the first room 401 into the second room 402. During this movement the client 950 starts from position 950 and reaches the positions 960, 961, 962, 963. Position 963 is the end position of the movement. According to the present invention it is advantageously possible to provide a non noticeable interruption during moving from one to the other room, which means that e.g. server 956 takes more and more sound data over from server 952 (e.g. 0% at position 950, 25% at position 960, 50% at position 961, 75% at position 962, 100% at position 963). The positions between the starting position 950 and the end position 963 are not limited and would result in a value of related signal level from 0% to 100%.

The following table 2 shows reached signal levels for each channel of the server. For better handover procedure the direction of the client may be useful to know, which could be preferably determined by an internal compass or by a gyro sensor or an acceleration sensor in the client.

TABLE 2
Allocation of signal levels

| | | | Signal | Signal | Signal | Signal |
|---|---|---|---|---|---|---|
| | | | level | level | level | level |
| | Position | Direction | Channel | Channel | Channel | Channel |
| Location | of | of | Left | Left | Right | Right |
| of Client | Server | Server | Rear | Front | Front | Rear |
| Room 401 | 950 | 970 | 951 | 952 | 954 | 953 |
| | | | (100%) | (100%) | (100%) | (100%) |
| Room 401 | 960 | 970 | 951 | 952 | 954 | 953 |
| | | | (75%) | (75%) | (75%) | (75%) |
| | | | 952 | 956 | 958 | 954 |
| | | | (25%) | (25%) | (25%) | (25%) |
| Room | 961 | 970 | 951 | 952 | 954 | 954 |
| 401-402 | | | (50%) | (50%) | (50%) | (50%) |
| | | | 952 | 956 | 958 | 953 |
| | | | (50%) | (50%) | (50%) | (50%) |
| Room 402 | 962 | 970 | 952 | 956 | 958 | 954 |
| | | | (25%) | (25%) | (25%) | (25%) |
| | | | 956 | 957 | 959 | 958 |
| | | | (75%) | (75%) | (75%) | (75%) |
| Room 402 | 963 | 970 | 956 | 957 | 959 | 958 |
| | | | (100%) | (100%) | (100%) | (100%) |

According to the present invention it is advantageously possible to provide surround sound to a group of mobile devices around a centered device, even if the devices are moving. In case of moving devices the position of the devices need to be updated and known by the server(s). Surround data can be streamed or, calculated by a server or several clients, based on processing power of the devices. The surround data can be streamed to one or more centered devices (clients), even if the devices are moving, and adopt the surround data according to their position. Depending on the location of the devices, handover between one or more rooms, by optional support of using an internal compass of devices or by a gyro sensor or an acceleration sensor, is also intended.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-12. (canceled)

13. A method for transferring audio data in a mobile radio network, the mobile radio network including a first mobile device in a first location and a second mobile device in a second location, the method comprising:
transmitting, by the first mobile device, a pilot signal to the second mobile device;
measuring, by the second mobile device, a signal strength of the pilot signal;
transmitting, by the second mobile device, information related to the signal strength of the pilot signal to the first mobile device;
determining, by the first mobile device, the second location relative to the first location based on the information related to the signal strength; and
transmitting, by the first mobile device, an audio signal based on the second location to the second mobile device.

14. The method according to claim 13, wherein at least one of the pilot signal, the information related to the signal strength, or the audio signal are transmitted using Bluetooth, NFC (Near Field Communication), RFD (Radio Frequency identification), WIMAX (Worldwide interoperability for Microwave Access), or WLAN (Wireless Local Area Network) connection.

15. The method according to claim 13, further comprising:
receiving, by the first mobile device, sound data from a local memory device, wherein the audio signal is generated based on the sound data.

16. The method according to claim 15, wherein the local memory device is at least one of a memory stick or a network entity.

17. The method according to claim 15, wherein the sound data is received using a Bluetooth, NEC (Near Field Communication), RFID (Radio Frequency Identification), WIMAX (Worldwide Interoperability for Microwave Access), or WLAN (Wireless Local Area Network) connection.

18. The method according to claim 15, wherein the sound data comprises at least one of mono sound, stereo sound, or surround sound information.

19. The method according to claim 13, further comprising:
determining, by the first mobile device, sound capabilities of the second mobile device;
wherein the first mobile device provides the audio signal to the second mobile device based on the sound capabilities.

20. The method according to claim 19, wherein the sound capabilities comprise at least one of data processing capacity, battery capacity, or speaker volume level.

21. The method according to claim 19, wherein the first mobile device determines locations and sound capabilities of a plurality of second mobile devices; wherein the first mobile device generates a surround sound depending on the locations and the sound capabilities of the plurality of second mobile devices; and wherein each of the plurality of second mobile devices contributes a portion of the surround sound.

22. The method according to claim 21, wherein mobile devices entering or leaving the proximity of the first mobile device are added to or removed from the plurality of second mobile devices.

23. The method according to claim 13, wherein an internal compass or a gyro sensor or an acceleration sensor is used for determination of the direction of the second mobile device relative to the first mobile device.

24. A system for transferring audio data in a mobile radio network, the system comprising:
a first mobile device in a first location; and
a second mobile device in a second location;
wherein the first mobile device is configured to transmit a pilot signal to the second mobile device;
wherein the second mobile device is configured to measure a signal strength of the pilot signal, and to transmit information related to the signal strength of the pilot signal to the first mobile device; and
wherein the first mobile device is further configured to determine the second location relative to the first location based on the information related to the signal strength, and to transmit an audio signal based on the second location to the second mobile device.

25. One or more non-transitory computer-readable media, having computer-executable instructions stored thereon for transferring audio data in a mobile radio network, the mobile radio network including a first mobile device in a first location and a second mobile device in a second location, the computer-executable instructions, when executed by a processor, causing the following steps to be performed:
transmitting, by the first mobile device, a pilot signal to the second mobile device;
measuring, by the second mobile device, a signal strength of the pilot signal;
transmitting, by the second mobile device, information related to the signal strength of the pilot signal to the first mobile device;
determining, by the first mobile device, the second location relative to the first location based on the information related to the signal strength; and
transmitting, by the first mobile device, an audio signal based on the second location to the second mobile device.
